(19) United States
(12) Patent Application Publication
(10) Pub. No.: US 2025/0324243 A1
(43) Pub. Date: Oct. 16, 2025

(54) INITIATING SECURE COMMUNICATION BY A WIRELESS AMBIENT POWER (AMP) DEVICE

(71) Applicant: Cypress Semiconductor Corporation, San Jose, CA (US)

(72) Inventors: Hui Luo, Marlboro, NJ (US); Rakesh Taori, McKinney, TX (US)

(73) Assignee: Cypress Semiconductor Corporation, San Jose, CA (US)

(21) Appl. No.: 18/635,460

(22) Filed: Apr. 15, 2024

(51) Int. Cl. H04W 12/03; H04W 12/00; H04W 12/043; H04W 12/06; H04W 12/106

(52) U.S. Cl. CPC H04W 12/03; H04W 12/009; H04W 12/043; H04W 12/06; H04W 12/106

(57) ABSTRACT

A method including determining, by an ambient power (AMP) device that harvests environmental energy, one or more first authentication and key management (AKM) parameters, and transmitting, by the AMP device to a powered wireless device, an initialization request frame comprising one or more frame-exchange parameters and the one or more first AKM parameters with which the powered wireless device is to establish an encrypted wireless communication session with the AMP device.

### TECHNICAL FIELD

This disclosure relates to wireless devices and, more specifically, to initiating secure communication by a wireless ambient power (AMP) device.

### BACKGROUND

Radio frequency (RF) wireless devices have grown in type and capability. In some wireless local area networks (WLANs), ambient power (AMP) devices, which harvest energy from the environment, can be effectively deployed as low cost wireless data collection sensors. Some use cases include tagging containers of retail products traveling from and between warehouses and tagging luggage being transported from and between air transportation and within airports. Other use cases include tracking or reporting environmental data such as temperature, proximity, pressure, or light data collected by a sensor. Due to the limited power available for processing incoming requests, communications with AMP devices are not secured and are often initiated by a non-AMP device (e.g., a powered wireless device).

### BRIEF DESCRIPTION OF THE DRAWINGS

FIG. 1 is a block diagram of an exemplary wireless network configured with RF band arrangements for downlink and uplink transmissions between a powered wireless device and an AMP device according to various embodiments.

FIG. 2A is a flow diagram of an example method for initiating secure communication by a wireless AMP device, according to some aspects of the disclosure.

FIG. 2B is a flow diagram of an example method for initiating secure communication by a wireless AMP device, according to some aspects of the disclosure.

FIG. 2C is a flow diagram of an example method for initiating secure communication by a wireless AMP device, according to some aspects of the disclosure.

FIG. 3 is a flow diagram of an example method for initiating secure communication by a wireless AMP device, according to other aspects of the disclosure.

FIG. 4A is a flow diagram of a method for initiating secure communication by a wireless AMP device, according to some aspects of the disclosure.

FIG. 4B is a flow diagram of a method for initiating secure communication by a wireless AMP device, according to some aspects of the disclosure.

FIG. 5 is a simplified block diagram of an example wireless device, which may represent any of the powered wireless device or client wireless devices discussed herein according to aspects of the disclosure.

### DETAILED DESCRIPTION

The following description sets forth numerous specific details such as examples of specific systems, devices, components, methods, and so forth, in order to provide a good understanding of various embodiments of initiating secure communication by a wireless ambient power (AMP) device. Some wireless AMP devices, e.g., AMP wireless clients, are simple wireless devices needing little processing power and memory, and thus can operate with little power. These AMP devices harvest (or scavenge) energy from the environment sufficient for brief and reduced processing. For example, AMP devices may communicate an identifier (ID) and/or other data being gathered by a sensor of or that is coupled to the AMP device. Powered wireless devices, such as routers, access points, client devices, etc., may be so referenced within mesh networks because the devices are receiving external continuous power, in contrast to AMP devices which do not receive continuous external power.

As discussed previously, due to the limited power available for receiving and processing incoming requests, as well as processing and transmitting outgoing responses, communication sessions with wireless AMP devices (e.g., also referred to herein as “AMP devices”) are often unencrypted. Often, establishing and maintaining an encrypted communication session requires each device participating in the encrypted communication session to maintain constant communication. This type of constant communication is not always possible or feasible for an AMP device. Further, typical communication in a WLAN between wireless clients and powered wireless devices requires extensive handshake protocols to ensure authentication and verification of connected devices (e.g., to establish a secured network or wireless communication session) in addition to encryption of data exchanged between the AMP wireless clients and powered wireless devices (e.g., once the secured wireless communication session is established). For example, many encryption methods can require two devices to transmit several frames of data in order to authorize each device, then several frames to establish an encryption (e.g., determine respective encryption keys) and then one or more frames to transmit and receive encrypted data. These more extensive protocol-based attachment methods are inconsistent with the low-power nature of the AMP devices due to the amount of power required. Without encryption, AMP devices may not be deployed in many practical settings, due to the risk of transmitting and receiving unencrypted data, which risks are increasingly of concern related to Internet of Things (IoT) devices.

Communication between a powered wireless device and an AMP device is often initiated by the powered wireless device. If the powered wireless device is unaware of the location, existence, proximity, etc., of the AMP device, the powered wireless device will be unable to initiate a procedure to establish communication with the AMP device. For example, an AMP device may be deployed in a first location, but may be transported (intentionally or unintentionally) to a second location. If a powered wireless device does not know to look for the AMP device (e.g., initiate a communication with the AMP device) in the second location, the powered wireless device may be unlikely to initiate a communication with the AMP device in the second location.

Aspects of the present disclosure resolve these and other deficiencies with known approaches to employing AMP devices in WLAN-based systems, by providing a method for initiating secure communication by a wireless ambient power (AMP) device. In some embodiments, the present disclosure provides various methods and systems in which an AMP device can initiate an encrypted communication session with a powered wireless device via a minimal exchange of data exchange frames. In some embodiments, the powered wireless device establishes the encrypted communication session with the AMP device. That is, the AMP device can “invite” (e.g., request) the powered wireless device to begin the process of establishing the encrypted communication session. In some embodiments, authentication and key generation may be embedded in a brief data exchange initiated by the powered wireless device, thus eliminating the need for any extra frame exchanges for establishing a secure association state.

In some embodiments, authentication and key generation for the powered wireless device can be performed by a network server communicatively coupled to the powered wireless device. The network server can authorize, on behalf of a particular powered wireless device, a communication between the AMP device and the particular powered wireless device. Thus, the network server can provide the AMP device with the functionality of dynamic user access control and credential management of powered wireless devices.

For example, in some embodiments, the network server, on behalf of the powered wireless device, generates an encryption key before mutual authentication, just at the time when the powered wireless device needs the encryption key to encrypt a data request frame. Later, the powered wireless device-to-AMP device authentication can be performed at the AMP device after the AMP device receives the encrypted data request frame. In the same manner, key generation at the AMP device can be performed before mutual authentication, just at the time when the AMP device needs the encryption key to encrypt a data response frame. Later, the AMP device-to-powered wireless device authentication can be performed at the powered wireless device (e.g., using information obtained from the securely coupled network server) after the powered wireless device receives the data response frame. At this point, in at least some embodiments, the one-shot encrypted data exchange finishes and the mutual authentication finishes at the same time.

In some embodiments, for example, authentication information and encryption key information is embedded into the data exchange frames that contain encrypted data. In this way, authentication between the devices can be accomplished at the same time that encrypted data is transmitted, thus reducing the quantity of frames required to transmit/receive an authenticated and encrypted communication. That is, the AMP device can receive encrypted data from the powered wireless device before the AMP device has authorized the powered wireless device, and similarly, the powered wireless device can receive encrypted data from the AMP device before the powered wireless device has authorized the AMP device. The powered wireless device can perform an additional operation to authorize the AMP device (e.g., by communicating with a network server that has a shared secret with the AMP device).

More specifically, the AMP device can receive encrypted data from the powered wireless device alongside authorization information for the powered wireless device. The AMP device can authorize the powered wireless device as an authorized sender, decrypt the encrypted data, and send encrypted data and authorization information to the powered wireless device in a quick series of low-power processing operations. This series of quick operations can reduce the time the AMP device needs to maintain power. The powered wireless device can receive encrypted data from the AMP device, authorize the AMP device as an authorized sender with the help of the network server, and decrypt the encrypted data.

In some embodiments, the network server receives an access request packet from the powered wireless device (related to an AMP device). The network server can determine (e.g., using access tables, etc.) whether the powered wireless device is authorized to communicate with the AMP device. If the powered wireless device is authorized to communicate with the AMP device, the network server can use a secret shared with the AMP device to determine authentication and key management (AKM) parameters with which the powered wireless device can initiate an encrypted communication with the AMP device. In some embodiments, the shared secret is negotiated based on a networking protocol, pre-programmed to the AMP device and/or powered wireless device during manufacturing, or otherwise configured before deployment of the AMP device and/or powered wireless device in an operational network. In some embodiments, the network server generates an encryption key. The network server can communicate the AKM parameters to the powered wireless device in a data access response packet. Once the powered wireless device receives the AKM parameters (and in some embodiments, the encryption key), the powered wireless device can transmit, to the AMP device, a data request including encrypted data and at least one of the AKM parameters received from the network server.

In related embodiments, for example, the powered wireless device is configured to transmit an identification request frame to an AMP device. The powered wireless device can receive an identification response frame from the AMP device that includes the first AKM parameters, an ID of the AMP device, and a network address of a network server. After the identification response frame is verified, the powered wireless device can transmit an access request packet to the network server requesting authorization to initiate an encrypted communication with the AMP device. The powered wireless device can receive second AKM parameters and an encryption key from the network server. In some embodiments, the powered wireless device can further transmit a data request and receive a respective data response using a similar approach that will be discussed in more detail.

In some embodiments, for example, an AMP device is configured to receive an identification request frame from a powered wireless device. After the identification request frame has been verified by the AMP device, the AMP device uses a secret that is shared with a network server to determine authentication and key management (AKM) parameters. The AMP device can send the AKM parameters to the powered wireless device along with a network address of a network server and an ID of the AMP device. The powered wireless device can use the AKM parameters and ID of the AMP device to obtain second AKM parameters and an encryption key from the network server. In some embodiments, the AMP device further receives a data request from the powered wireless device containing the AKM parameters and encrypted data and transmits a respective data response with requested data or information.

Advantages of the present disclosure include, but are not limited to, initiating secure communication by a wireless ambient power (AMP) device, despite the fact that the AMP devices are able to operate infrequently, at low power, and with minimal stored data. The addition of an authentication network server allows the AMP device to store, and subsequently transmit, a static network address (e.g., a uniform resource locator (URL) or other network address) to the network server with which the network server can determine whether the powered wireless device is authorized to communicate with the AMP device. As such, the AMP device is not performing the dynamic user access control, which could have power requirements that exceed the power available to the AMP device. Additional advantages will be apparent to those skilled in the art of WLAN-related data collection and tracking systems that employ AMP devices, and are further discussed below.

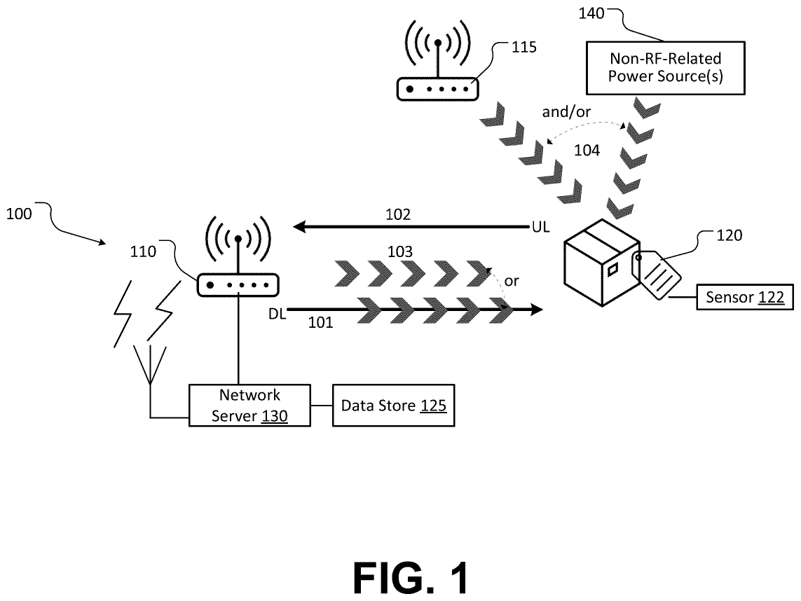

FIG. 1 is a block diagram of an exemplary wireless network 100 configured with RF band arrangements for downlink (DL) and uplink (UL) transmissions between a powered wireless device 110 and an AMP device 120, e.g., AMP client wireless device, according to various embodiments. In some embodiments, the powered wireless device 110 is an access point, a router, a wireless hub, a mobile hotspot device, or a wireless (or cellular) base station, a client device, or the like that is externally powered. In some embodiments, the powered wireless device 110 can be externally powered by a direct current (DC) voltage sources and/or alternating current (AC) power sources. For example, the powered wireless device 110 can be externally powered by DC power source such as a battery (e.g., a laptop, or mobile phone battery). In another example, the powered wireless device 110 can be externally powered by an AC power source such as a wall socket, or building mains voltage. In various embodiments, the AMP device 120 is a wireless identification tag or a low-power client wireless device or AMP station (STA). As illustrated, the wireless network 100 can include a second powered wireless device 115, a data store 125, and a non-RF-related power source 140.

In some embodiments, the powered wireless device 110 communicates to a network server 130 to upload data to a cloud. In some embodiments, the network server 130 can be a WLAN server. In these embodiments, the network server 130 includes or is coupled to a data store 125 of volatile or non-volatile memory, e.g., within cloud-based storage that exists in a local cloud or edge cloud or the like. In this way, data/information collected by the powered wireless device 110 can be stored, by the network server 130, in the data store 125 where the data can optionally be indexed against respective AMP devices 120, e.g., in a database or the like. In various embodiments, the data or information collected and stored includes an identification and/or a location of the AMP device 120, temperature data, humidity data, pressure data, level data (e.g., level of fluid or gas within a container), and/or other data associated with an environment of the AMP device 120. In some embodiments, the data or information is a log or array of information to include a data history of the AMP device 120 that includes environmental data or information collected over time. The sensor-related data may be detected from a sensor 122 (or multiple sensors) included within or coupled to the AMP device 120.

In some embodiments, the network server 130 can perform one or more authentication operations on behalf of the powered wireless device 110. The network server 130 can determine whether the powered wireless device 110 is authorized to communicate with the AMP device 120. If the powered wireless device 110 is authorized to communicate with the AMP device 120, the network server 130 can provide communication parameters to the powered wireless device 110 for the communication between the powered wireless device 110 and the AMP device 120. In some embodiments, the communication parameters can include one or more AKM parameters, an encryption key, temporary secrets, or other indicators that cause the powered wireless device 110 to initiate an encrypted wireless communication session with the AMP device 120.

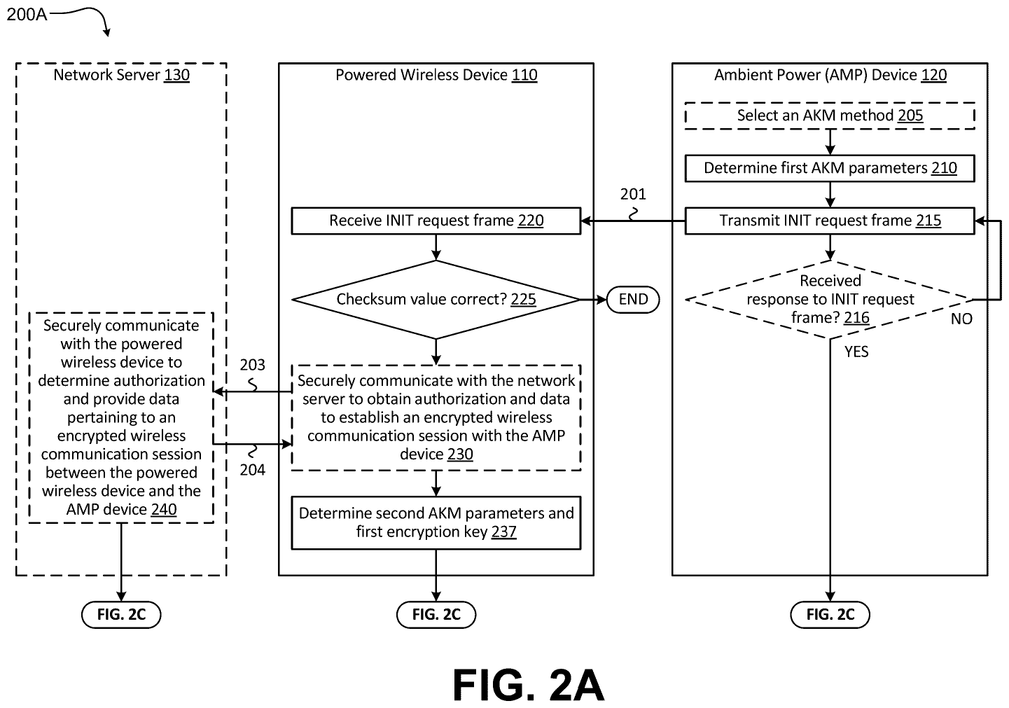

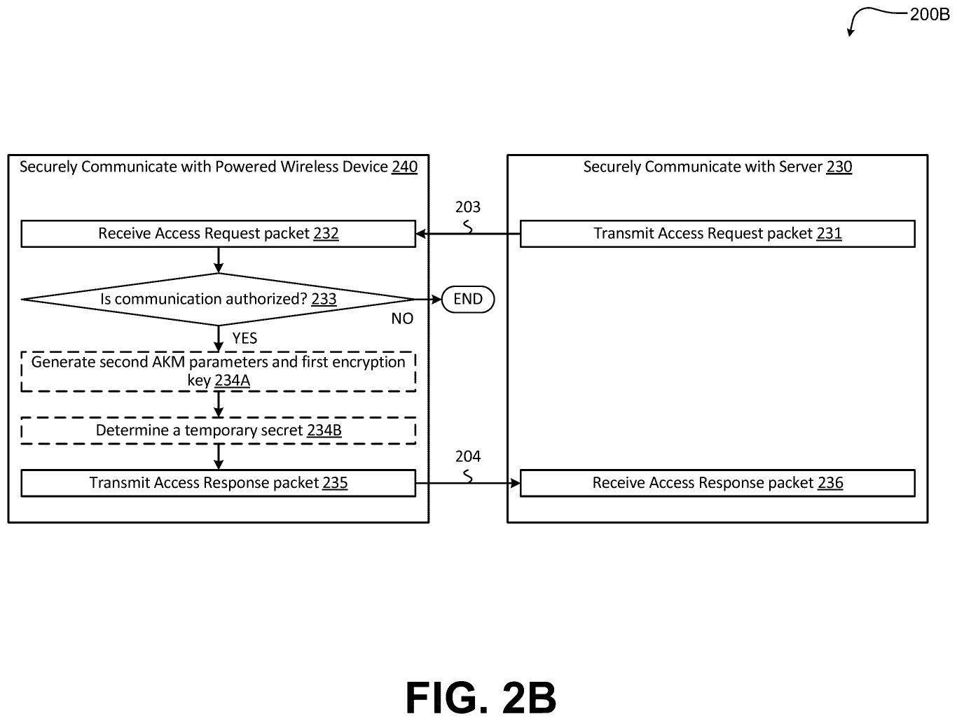

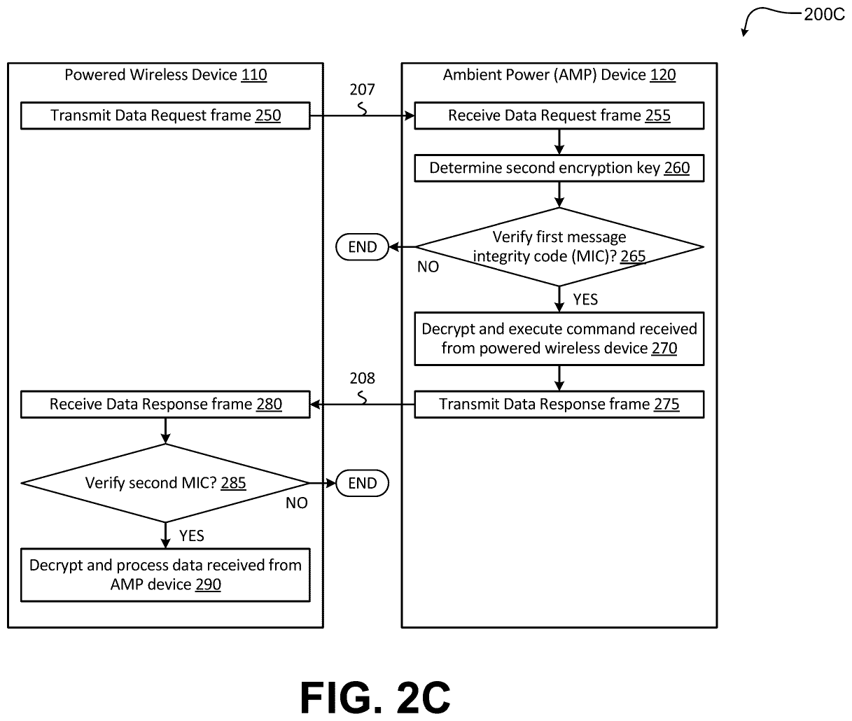

In some embodiments, the network server 130 determines whether the powered wireless device 110 is authorized to communicate with the AMP device 120 based on an ID of the AMP device 120 and an ID associated with the powered wireless device 110 (e.g., a user ID). For example, the powered wireless device 110 can be directed to the network server 130 by the AMP device 120 (e.g., using a network address such as a URL) when the powered wireless device 110 initiates a procedure to establish an encrypted wireless communication session with the AMP device 120. The powered wireless device 110 can request authorization from the network server 130 to communicate with the AMP device 120. If the network server 130 determines the powered wireless device 110 is authorized to communicate with the AMP device 120, the network server 130 can provide one or more authentication and key management (AKM) parameters, an encryption key, and/or a temporary secret to the powered wireless device 110. The temporary secret can be used by the powered wireless device 110 to generate the one or more AKM parameters and/or an encryption key. Additional details are described below in FIGS. 2A-5.

In many embodiments, there are one or more powered wireless devices 110 and many client wireless devices, which are AMP devices 120, as disclosed herein. Ambient power (AMP) devices are energized by harvesting energy from RF signals (e.g., RF-related power sources) and/or from non-RF-related power sources 140 (e.g., the AMP device 120 can harvest environmental energy). In various embodiments, harvested energy from RF-related power sources are from in-band RF power sources (e.g., within the same RF band being used for downlink/uplink (DL/UL) transmissions) or out-of-band RF power sources (e.g., downlink (DL) and uplink (UL) transmissions take place in different RF bands compared to RF band being used for energy harvesting). In additional embodiments, non-RF-related power sources include solar or photovoltaic cells (convert ambient sunlight into electricity), thermoelectric generators (convert temperature gradients into electricity), vibration energy harvesting using piezoelectric, electrostatic, and electromagnetic converters (convert mechanical vibrations from the environment into electricity), miniature wind turbines (convert ambient wind energy into electrical power), pressure differential energy harvesting, dynamos or wearable harvesters (convert human or animal motion into electrical energy), and other such energy-harvesting mechanisms. In some embodiments, the AMP device 120 can harvest environmental energy using one or more collection circuits (e.g., AMP collection circuits). The collection circuits can include circuitry that can harvest any of the above-mentioned electrical potential energy (e.g., the collection circuit can be configured to harvest environmental energy).

In some embodiments, the powered wireless device 110 does not transmit the energizing RF signal. For example, in other embodiments, the wireless network 100 further includes a second powered wireless device 115 and/or non-RF-related power sources 140 that provide RF power and/or non-RF power, respectively, from which the AMP device 120 harvests environmental energy (e.g., from power sources other than from the powered wireless device 110 associated with the DL/UL transmissions). In at least some embodiments, the second powered wireless device 115 transmits an energizing RF signal (104) towards the client wireless device from which the client wireless device harvests energy. In further embodiments, the energizing signals (101) or (103) discussed with reference to FIG. 1A are combined with the energizing RF signal (104) of FIG. 1B. Further, non-RF-related energy harvesting may be employed alone or in combination with RF-related energy harvesting.

With additional reference to FIG. 1, in at least one embodiment, the powered wireless device 110 transmits a first wireless signal (101), which is a DL transmission, over a first RF band to the AMP device 120. In some embodiments, the first wireless signal includes a data packet requesting information from the AMP device 120. The AMP device 120 may receive the first wireless signal and parse the data packet to determine the requested information.

In these embodiments, the AMP device 120 transmits a second wireless signal (102), which is an UL transmission, over a second RF band to the powered wireless device 110 with a data packet with the requested information. In this way, the requested information or data (discussed previously) may be requested and received from the AMP device 120 through data packet exchange. In various embodiments, the powered wireless device 110 generates the first wireless signal employing technology such as Wi-Fi®, Bluetooth®, Bluetooth® Low Energy, Ultra-Wideband (UWB), Z-wave™, Zigbee®, LoRa™, Wi-SUN®, or other wireless protocol. In various embodiments, the AMP device 120 generates the second wireless signal employing technology such as Wi-Fi®, Bluetooth®, Bluetooth® Low Energy, Ultra-Wideband (UWB), Z-wave™, Zigbee®, LoRa™, Wi-SUN®, or other wireless protocol.

In some embodiments, the first RF band for DL transmission differs from the second RF band used for UL transmission. In some embodiments, the second RF band operates at a lower frequency range than that of the first RF band, e.g., as low frequencies consume less power. Lower frequencies also exhibit smaller path losses compared to higher frequencies and, at the same power, the wireless signals can be adequately received and decoded at a farther distance and propagate through or around obstacles better compared to higher frequencies. Further, RF and circuit design at lower frequencies can be far less complex compared to being designed for at higher frequency operation, keeping costs low for the AMP devices 120.

In some embodiments, the second RF band operates at a higher frequency range than that of the first RF band, e.g., higher frequency operations deploy wider channel bandwidths, which in turn allow a transmission of the same number of user bytes and finish earlier. The AMP device 120 may then receive and/or transmit for a shorter period of time, conserving power and providing a separate power consumption benefit. Accordingly, use of a higher frequency range or a lower frequency range with the UL transmission (compared to the DL transmission) may involve a cost-benefit analysis that weighs these benefits as between higher or lower frequency ranges.

In other embodiments, the first RF band is the same as the second RF band, but the DL transmission and the UL transmission occur over different frequencies with significant separation (e.g., more than a few 100 megahertz (MHz) within that same RF band. In these ways, both the technology and RF bands (or frequencies) can differ as between the DL/UL transmissions so that AMP devices 120 can operate at lower power while avoiding frequency conflicts between the DL and UL transmissions.

In various embodiments, the first wireless signal (101), e.g., transmitted in the first RF band, is also an energizing RF signal, illustrated with thick directional indicators, from which the AMP device 120 harvests environmental energy. In similar embodiments, the powered wireless device 110 instead transmits a separate energizing RF signal (103) towards the AMP device 120, but this separate energizing RF signal (103) is also within the first RF band, e.g., is not necessarily the same as the first wireless signal (101), but may be close in frequency. In alternative embodiments, the separate energizing RF signal (103) is transmitted over the second RF band, e.g., of the UL transmission, or is transmitted over an entirely different third RF band. Accordingly, in differing embodiments, the energizing RF signal (103) is sent over the first RF band, the second RF band, or the third RF band. For example, in some embodiments by way of example, the first RF band is 5.0 gigahertz (GHz), the second RF band may be 2.4 GHZ, and the third RF band may be 5.0 or 6.0 GHz, where the third RF band may also be employed by the powered wireless device 110 to communicate with other mobile stations (STA).

Data can be communicated between the powered wireless device 110, and the AMP device 120 as frames in a request-and-response protocol. The request-and-response protocol can be based on a secret that is shared between the network server 130 and the AMP device 120, as described above. The secret can be stored in the data store 125 (or other secure location) and programmed to the AMP device 120 during manufacturing or before deployment within an operational network.

In some embodiments, the request-and-response protocol between the powered wireless device 110 and the AMP device 120 is compatible with the carrier sense multiple access with collision avoidance (CSMA/CA) network protocol. In some embodiments, the request-and-response protocol between the powered wireless device 110 and the AMP device 120 is compatible with the request-to-send/clear-to-send (RTS/CTS) network protocol. In some embodiments, the request-and-response protocol between the powered wireless device 110 and the AMP device 120 is compatible with backscattering.

Frames can include information organized into five fields, as shown in Table 1:

TABLE 1

| First | Second | Third | Fourth | Fifth |
|---|---|---|---|---|
| Field | Field | Field | Field | Field |
| Recipient ID | Sender ID | Frame Type | Data Body | Frame |
| | | | | Check Data |

In various embodiments, the first field of the frame includes the recipient ID (e.g., the ID of the powered wireless device 110, or the ID of the AMP device 120). In some embodiments, the recipient ID is the media access control (MAC) address of the recipient device. In alternative embodiments, the recipient ID is a unique, pre-assigned ID, e.g., assigned at manufacturing or before deployment within an operational network. For example, in some embodiments, power harvested by the AMP device 120 is insufficient to perform program operations on non-volatile memory, and the AMP device 120 can have a unique ID programmed into non-volatile memory at an initial factory setup with external power. Requests received at the AMP device 120 can have the ID of the AMP device 120 in the first field. Responses received at the powered wireless device 110 can have the ID of the powered wireless device 110 in the first field. In some embodiments, the recipient ID identifies a particular subset of recipient devices (e.g., multiple AMP devices 120 120). For example, the recipient ID can be a subset of MAC addresses (e.g., a MAC multicast address) corresponding to the particular subset of AMP devices 120. In some embodiments, the recipient ID identifies any recipient device (e.g., any AMP device 120) within a wireless connection range of a sender device (e.g., the powered wireless device 110). For example, the recipient ID can be a MAC broadcast address, such as FF:FF:FF:FF:FF:FF.

In various embodiments, the second field of the frame includes the sender ID (e.g., the ID of the powered wireless device 110, or the ID of the AMP device 120). The characteristics of the sender ID can be the same as, or similar to, the characteristics described above with reference to the recipient ID. Requests sent from the powered wireless device 110 can have the ID of the powered wireless device 110 in the second field. Responses sent from the AMP device 120 can have the ID of the AMP device 120 in the second field.

In various embodiments, the third field of the frame includes the frame type, which can identify the type of frame, e.g., initialization request frame, ID response frame, data request frame, data response frame. In some embodiments, the frame type identified in the third field is based on or defines information located in the data body of the fourth field.

In various embodiments, the fourth field of the frame includes the data body, which can include frame-exchange parameters, data, commands, authentication and key management (AKM) parameters (e.g., Simultaneous Authentication of Equals (SAE)), cipher suites (e.g., Advanced Encryption Standard (AES), such as AES 128-bit (AES128)), physical layer (PHY) parameters for guiding frame transmission to reduce conflicts, and session information (e.g., a session number). In some embodiments, some portions of the data body can be secured, such as by encryption or hashing.

In some embodiments, the AKM parameters can include one or more cryptographic parameters. In some embodiments, the AKM parameters include a scalar value that can be an input into an encryption algorithm and an element value that can be an output of the encryption algorithm. In some embodiments, the encryption algorithm is associated with an elliptical curve, where the scalar value denotes a position on the elliptical curve, and the element value represents the position on the elliptical curve that is selected by the scalar value.

In various embodiments, the fifth field of the frame includes frame check data. The frame check data can be any data that can be used by the receiving device (e.g., the powered wireless device 110 or the AMP device 120 respectively) to verify that the frame was received without errors or modification. In some embodiments, the frame check data can include unsecured error check data such as checksum data, cyclic redundancy check (CRC) data, or secured (e.g., encrypted or hashed) error check data such as message integrity code (MIC) data depending on the application and level of network attachment.

FIG. 2A, is a flow diagram of an example method 200A for initiating secure communication by a wireless AMP device, according to some aspects of the disclosure. The method 200A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200A can be performed by processing logic of the powered wireless device 110, processing logic of the AMP device 120, and/or processing logic of the network server 130.

At operation 205, the processing logic of the AMP device 120 selects an authentication and key management (AKM) method for an encrypted wireless communication session between the powered wireless device 110 and the AMP device 120. The operation 205 is an optional operation, as illustrated by the dashed lines in FIG. 2A. In some embodiments, the operation 205 is performed during the operation 210, below. In some embodiments, the AMP device 120 is pre-programmed to operate with a specific AKM method. In some embodiments, the AMP device 120 can select an AKM method from multiple available AKM methods. AKM methods can include one or more of a password-based challenge and response, simultaneous authentication of equals (SAE), public/private key trust method (e.g., using security certificates), or the like. In some embodiments, the AKM method is based on a cipher block, where data is encrypted in fixed-size blocks (e.g., 64 bits, 128 bits, etc.). Plaintext is divided into blocks and each block is independently encrypted using the same encryption key, where encryption of each block can be dependent on encryption of a previous block. In alternative embodiments, the AKM method is based on a cipher stream, where data is encrypted bit by bit. Plaintext is combined with a pseudorandom stream of bits (e.g., cyphertext) using a bitwise exclusive-or (XOR) function.

At operation 210, the processing logic of the AMP device 120 determines first authentication and key management (AKM) parameters for the AMP device 120. In embodiments that perform the operation 205, the first AKM parameters for the AMP device 120 can be determined based on the selected AKM method of operation 205. In embodiments that do not perform the operation 205, the first AKM parameters for the AMP device 120 can be determined based on an AKM method (e.g., an AKM method pre-programmed to the AMP device 120).

In some embodiments, the first AKM parameters are determined based on a secret that is shared between the AMP device 120 and the powered wireless device 110. In some embodiments, the secret is based on an ID of the AMP device 120. The processing logic can retrieve, from memory of the powered wireless device 110, the secret shared with the AMP device 120. For example, the secret can be stored in memory (e.g., in a data structure, as an entry in a lookup table, a matrix, a linked list, a data file, or the like) based on an ID of the AMP device 120. In another example, a first secret can be stored (and used) with respect to a first one or more AMP device(s) 120, and a second secret can be stored (and used) with respect to a second one or more AMP device(s) 120. In alternative embodiments, the first AKM parameters are determined based on a secret that is shared between the AMP device 120 and the network server 130. In some embodiments, the first AKM parameters include a first scalar value and a first element value. The first scalar value can be a value selected by the AMP device 120 and used as input to a cryptographic algorithm to produce the first element value.

At operation 215, the processing logic of the AMP device 120 transmits an initialization (INIT) request frame 201. In some embodiments, the AMP device 120 sends multiple initialization request frames 201 (e.g., as is described in operation 216 below). The initialization request frame can include (i) one or more first AKM parameters, (ii) one or more frame-exchange parameters, (iii) an ID of the AMP device 120, (iv) a network address of the network server 130 (e.g., a uniform resource locator (URL) address), (v) a nonce value generated by the AMP device 120, and/or (vi) error-checking data (e.g., a checksum, cyclic redundancy check (CRC) data, or the like). The one or more first AKM parameters included in the initialization request frames 201 can be a first scalar value and a first element value. The frame-exchange parameters can include a session number. A session number can be a unique identifier for the communication session initiated with the initialization request frame 201. The session number can be discarded if the method 200A terminates. The ID of the AMP device 120 can be a MAC address of the AMP device 120, or another unique or semi-unique ID assigned during production and/or manufacturing of the AMP device 120. The network address of the network server 130 can point to an internal resource (e.g., locally hosted server within the same intranet/WLAN), or an external resource (e.g., an externally hosted server located outside of the local intranet/WLAN). The nonce value can be generated by the AMP device 120 for use when the network server 130 is authenticating on behalf of the powered wireless device 110 and the powered wireless device 110 is generating the AKM parameters and an encryption key. The nonce value can be generated based on the secret shared between the AMP device 120 and the network server 130. The error-checking data can be included to verify that the frame was transmitted and received with acceptable levels of error (e.g., to verify the frame was not intercepted and/or corrupted at transmission, during travel, or at receipt).

At operation 216, the processing logic of the AMP device 120 determines whether a response has been received to the initialization request frame 201. The operation 216 is an optional operation, illustrated by the dashed lines in FIG. 2A. The operation 216 can be performed by the processing logic of the AMP device 120 after the operation 215 has been performed. If no response to the initialization request frame 201 has been received, the processing logic of the AMP device 120 can return to operation 215 and retransmit an initialization request frame 201. The cycle between operation 215 and operation 216 can continue indefinitely, or until the processing logic of the AMP device 120 causes the AMP device 120 to receive a response to the initialization request frame (e.g., a data request frame 207, described below with reference to FIG. 2C). In some embodiments, the cycle between operation 215 and 216 can halt when the AMP device 120 loses power. In some embodiments, the cycle between operation 215 and operation 216 can be performed a predetermined number of times on a set cadence. For example, the cycle between operation 215 and operation 216 can be performed, for example, three times, and can be initiated, for example, once every minute. In some embodiments, the response to the initialization request frame 201 can be an ID request frame (not illustrated).

At operation 220, the processing logic of the powered wireless device 110 receives the initialization request frame 201 from the AMP device 120.

At operation 225, the processing logic of the powered wireless device 110 verifies whether the checksum of the received initialization request frame 201 is correct. If the error-checking value is not correct, the method 200A ends, e.g., the processing logic of the powered wireless device 110 terminates a procedure of establishing an authenticated and encrypted network session with the AMP device 120. If the error-checking value is correct, the processing logic of the powered wireless device 110 proceeds to operation 230.

At operation 230, the processing logic of the powered wireless device 110 securely communicates with the network server 130 to obtain authorization and data to establish an encrypted wireless communication session with the AMP device 120. In some embodiments, securely communicating with the network server 130 includes establishing a secure connection with the network server 130 using security protocols, such as any of Hypertext Transfer Protocol Secure (HTTPS), Authentication Authorization and Accounting (AAA) frameworks, Secure Socket Layer (SSL), Transport Layer Security (TLS), Internet Protocol Security (IPSec), Secure Shell (SSH), Zero Trust, and/or any combination thereof, prior to receiving the access request packets 203 or transmitting the access response packets 204.

At operation 240, the processing logic of the network server 130 securely communicates with the powered wireless device 110 to determine authorization and provide data pertaining to an encrypted wireless communication session between the powered wireless device 110 and the AMP device 120. In some embodiments, securely communicating with the powered wireless device 110 includes establishing a secure connection with the network server 130 using security protocols, such as one or more of those discussed with reference to operation 230, prior to receiving the access request packets 203 or transmitting the access response packets 204.

The operation 230 and the operation 240 are optional operations (as illustrated in FIG. 2A by dashed lines) that can be performed if a network server 130 (also optional, as illustrated) is used to authenticate the communication between the powered wireless device 110 and the AMP device 120 on behalf of the powered wireless device 110. If the network server 130 is not used for this authentication, the processing logic of the powered wireless device 110 can proceed from operation 225 to operation 237.

At operation 237, the processing logic of the powered wireless device 110 determines second AKM parameters and a first encryption key. In some embodiments, the network server 130 is not used to authenticate communication between the powered wireless device 110 and the AMP device 120 on behalf of the powered wireless device 110. The powered wireless device 110 can generate (e.g., determine) second AKM parameters and a first encryption key using a secret that is shared between the powered wireless device 110 and the AMP device 120. In alternative embodiments, the second AKM parameters and first encryption key are generated by the network server 130 at operation 234A. The powered wireless device 110 receives the second AKM parameters and first encryption key from the network server 130 at operation 236 (FIG. 2B) in the access response packet 204. The powered wireless device 110 can determine (e.g., extract) the second AKM parameters and first encryption key from the access response packet 204. In other alternative embodiments, the second AKM parameters and first encryption key are generated by the powered wireless device 110 based on a temporary secret generated by the network server 130 at operation 234B (FIG. 2B). The powered wireless device 110 receives the temporary secret from the network server 130 at operation 236 in the access response packet 204, as illustrated in FIG. 2B. The powered wireless device 110 can determine (e.g., generate) the second AKM parameters and first encryption key based on the temporary secret in the access response packet 204.

FIG. 2B, is a flow diagram of an example method 200B for initiating secure communication by a wireless AMP device, according to some aspects of the disclosure. The method 200B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200B can be performed by processing logic of the powered wireless device 110, processing logic of the AMP device 120, and/or processing logic of the network server 130. In some embodiments, the method 200B is a continuation of the method 200A.

At operation 231, the processing logic of the powered wireless device 110 can transmit an access request packet 203. The access request packet can include an ID of the AMP device 120 and a user ID corresponding to the powered wireless device 110. In some embodiments, the access request packet 203 can further include one or more AKM parameters, one or more user credentials corresponding to the user ID, and/or a nonce value generated at the AMP device 120. The nonce value can be generated based on the secret shared between the AMP device 120 and the network server 130.

At operation 232, the processing logic of the network server 130 can receive the access request packet 203. In some embodiments, the processing logic of the network server 130 can determine whether the access request packet 203 includes the one or more AKM parameters. In some embodiments, the processing logic of the network server 130 can determine whether the access request packet 203 includes the nonce value.

At operation 233, the processing logic of the network server 130 can determine whether communication between the powered wireless device 110 and the AMP device 120 is authorized. If the processing logic of the network server 130 determines that communication between the powered wireless device 110 and the AMP device 120 is not authorized, the method 200B ends, e.g., the procedure for establishing an authenticated and encrypted wireless communication session between the powered wireless device 110 and the AMP device 120 is terminated.

In some embodiments, the processing logic of the network server 130 maintains a data structure (e.g., lookup table, matrix, a linked list, a data file, or the like) of user IDs that are authorized to communicate with respective AMP IDs. In some embodiments, the data structure can be stored at data store 125 (described with reference to FIG. 1). In some embodiments, the network server 130 can include a user authentication module or process that authorizes a powered wireless device 110 to access a respective AMP device 120 (based on the ID of the AMP device 120) responsive to the user ID and corresponding user credentials satisfying a user credential criterion. For example, a user ID and password (e.g., corresponding user credential) can be authenticated by the network server 130, and the network server 130 can determine that the powered wireless device 110 associated with the user ID is authorized to communicate with the AMP device 120.

The authentication parameters and/or data structures stored on the network server 130 that correspond to the AMP device 120 (based on the ID of the AMP device 120) can be changed based on user access requirements and credential management parameters for the AMP device 120. For example, an organization with multiple powered wireless devices 110 can deploy multiple AMP devices 120. Because the AMP devices 120 lack sufficient power to be reprogrammed while deployed in an operational network, changes to access permissions (e.g., whether a particular powered wireless device is authorized to communicate with a particular AMP device) cannot be executed at the AMP device 120. Instead, the static network address programmed to the particular AMP device can point to the network server 130, and a portion of the network server 130 associated with the ID of the particular AMP device can store a authentication data structure identifying particular powered wireless devices (or user IDs) that are authorized to communicate with the particular AMP device. If a new user or powered wireless device 110 is added to the organization, the authentication data structure for the particular AMP device can be updated to reflect whether the new user or powered wireless device is authorized to communicate with the particular AMP device. In some embodiments, one authentication data structure is maintained for multiple AMP devices 120. In some embodiments, if the processing logic of the network server 130 identifies the user ID (or other identifier) corresponding to the powered wireless device 110 in the authentication data structure, the processing logic of the network server 130 can determine that the powered wireless device 110 is authorized to communicate with the AMP device 120.

Operations 234A and 234B are alternative operations that follow operation 233. In some embodiments, operation 234A is performed following operation 233. In alternative embodiments, operation 234B is performed following operation 233.

At operation 234A, the processing logic of the network server 130 can determine second AKM parameters and a first encryption key. In some embodiments, operation 234A is performed when the access request packet 203 includes one or more first AKM parameters. The processing logic of the network server 130 can determine the second AKM parameters using the first AKM parameters received from the powered wireless device 110 (e.g., in the access request packet), and the secret shared with the AMP device 120 (e.g., the secret shared between the network server 130 and the AMP device 120). The processing logic of the network server 130 can further determine a first encryption key using at least the second AKM parameters.

At operation 234B, the processing logic of the network server 130 can determine a temporary secret. In some embodiments, operation 234B is performed when the access request packet 203 includes the nonce value generated by the AMP device 120. The processing logic of the network server 130 can determine a temporary secret using at least the nonce value and the secret shared with the AMP device 120 (e.g., a primary secret shared between the network server 130 and the AMP device 120).

At operation 235, the processing logic of the network server 130 can transmit an access response packet 204 to the powered wireless device 110. In some embodiments, the access response packet 204 includes the one or more second AKM parameters and encryption key determined by the network server 130. In some embodiments, the access response packet 204 includes the temporary secret determined by the network server 130. In some embodiments, the access response packet 204 includes an indicator that the powered wireless device 110 is authorized to initiate an encrypted wireless communication session with the AMP device 120.

At operation 236, the processing logic of the powered wireless device 110 receives the access response packet 204.

It can be noted that in most embodiments, if the processing logic of the powered wireless device 110 does not perform the optional operation 230 and the processing logic of the network server 130 does not perform the optional operation 240, the second AKM parameters and first encryption key can be generated based on secret shared between the powered wireless device 110 and the AMP device 120. Similarly, in most embodiments, if the processing logic of the powered wireless device 110 performs the optional operation 230 and the processing logic of the network server 130 performs the optional operation 240, the second AKM parameters and first encryption key can be generated (i) at the network server 130 using a secret shared between the network server 130 and the AMP device 120, or (ii) at the powered wireless device 110 using a temporary secret generated by the network server 130 based on at least a primary secret shared between the network server 130 and the AMP device 120.

FIG. 2C, is a flow diagram of an example method 200C for initiating secure communication by a wireless AMP device, according to some aspects of the disclosure. The method 200C can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200C can be performed by processing logic of the powered wireless device 110, processing logic of the AMP device 120, and/or processing logic of the network server 130. In some embodiments, the method 200C is a continuation of the method 200A and/or a continuation of the method 200B.

At operation 250, the processing logic of the powered wireless device 110 transmits a data request frame 207 to the AMP device 120. In some embodiments, the data request frame 207 includes one or more frame-exchange parameters, one or more second AKM parameters, a first message integrity code (MIC), and a command. In some embodiments, processing logic of the powered wireless device 110 generates the first MIC using a first portion of the first encryption key. In some embodiments, the command is encrypted. In some embodiments, processing logic of the powered wireless device 110 encrypts the command using a second portion of the first encryption key. In some embodiments, the frame-exchange parameters include a cipher type (e.g., a cipher suite). The cipher type can be associated with an AKM method. In some embodiments, the cipher type is associated with a cipher algorithm (as described above). As described above, AMP device 120 selects the AKM method. In some embodiments, the powered wireless device 110 can select the AKM method.

At operation 255, the processing logic of the AMP device 120 receives the data request frame 207 from the powered wireless device 110.

At operation 260, the processing logic of the AMP device 120 determines a second encryption key for the AMP device 120. In some embodiments, the second encryption key for the AMP device 120 is determined from information received in the data request frame 207. In some embodiments, the second encryption key for the AMP device 120 is determined from the first AKM parameters of the AMP device 120 and the second AKM parameters received in the data request frame 207.

At operation 265, the processing logic of the AMP device 120 verifies the first message integrity code (MIC) of the data request frame 207. If the first MIC cannot be verified, the method 200C ends, e.g., the processing logic of the AMP device 120 terminates an encrypted network session initiated with the powered wireless device 110. If the first MIC is verified, the processing logic of the AMP device 120 proceeds to operation 270. In some embodiments, the processing logic of the AMP device 120 uses a first portion of the second encryption key to verify the first MIC.

At operation 270, the processing logic of the AMP device 120 decrypts the encrypted command received from the powered wireless device 110 to generate a decrypted command. Also at operation 270, the processing logic of the AMP device 120 executes the decrypted command, which may include generating a data response frame 208. In some embodiments, the processing logic of the AMP device 120 uses a second portion of the second encryption key to decrypt the encrypted command received in the data request frame 207.

At operation 275, the processing logic of the AMP device 120 transmits a data response frame 208 to the powered wireless device 110. In some embodiments, the data response frame 208 includes at least one of the one or more frame-exchange parameters, a second MIC, and data including at least status or environmental data retrieved from a coupled sensor (or the like). In some embodiments, the processing logic of the AMP device 120 generates the second MIC using a first portion of the second encryption key. In some embodiments, the data is encrypted. The processing logic of the AMP device 120 can encrypt data using a second portion of the second encryption key.

At operation 280, the processing logic of the powered wireless device 110 receives the data response frame 208 from the AMP device 120.

At operation 285, the processing logic of the powered wireless device 110 verifies the second MIC of the data response frame 208. If the second MIC cannot be verified, the method 200C ends, e.g., the processing logic of the powered wireless device 110 terminates the encrypted network session with the AMP device 120. If the second MIC is verified, processing logic of the powered wireless device 110 proceeds to operation 290. In some embodiments, the processing logic of the powered wireless device 110 uses a first portion of the first encryption key to verify the second MIC.

At operation 290, the processing logic of the powered wireless device 110 decrypts the encrypted data received from the AMP device 120 to generated decrypted data. Also at operation 290, the processing logic of the powered wireless device 110 processes the decrypted data received from the AMP device 120 in the data response frame 208. In some embodiments, the processing logic of the powered wireless device 110 uses a second portion of the first encryption key to decrypt the encrypted data received in the data response frame 208.

In some embodiments, the processing logic of the powered wireless device 110 determines whether to request additional data from the AMP device 120 (not illustrated). Upon determining to request additional data from the AMP device 120, the processing logic of the powered wireless device 110 can transmit a second data request frame (not illustrated) to the AMP device 120 e.g., similar to operation 255. The second data request frame can include at least one of the one or more frame-exchange parameters, a third MIC, and a second command. The processing logic of the AMP device 120 can receive the second data request frame, and verify the third MIC of the second data request frame, e.g., similar to operations 255 and 265, respectively. If the MIC cannot be verified, the method 200C ends, e.g., the processing logic of the AMP device 120 terminates the encrypted network session initiated with the powered wireless device 110. If the third MIC is verified, the processing logic of the AMP device 120 can decrypt and execute the command received in the second data request, e.g., similar to operation 270. The processing logic of the AMP device 120 can transmit a second data response frame (not illustrated) to the powered wireless device 110. The second data response frame can include at least one of the one or more frame-exchange parameters a fourth MIC, and second data. The processing logic of the powered wireless device 110 can receive the second data response frame, and verify the fourth MIC of the second data response frame, e.g., similar to operations 280 and 285, respectively. If the MIC cannot be verified, the method 200C ends, e.g., the processing logic of the powered wireless device 110 terminates the encrypted network session initiated with the AMP device 120. If the fourth MIC is verified, the processing logic of the powered wireless device 110 can decrypt and process the data received in the second data response frame, e.g., similar to operation 290. In some embodiments, additional data requests and corresponding data responses can be transmitted and received until the powered wireless device 110 determines that no more data is to be collected from the AMP device 120, the AMP device 120 loses power, or the communication session otherwise terminates, e.g., the method 200C ends.

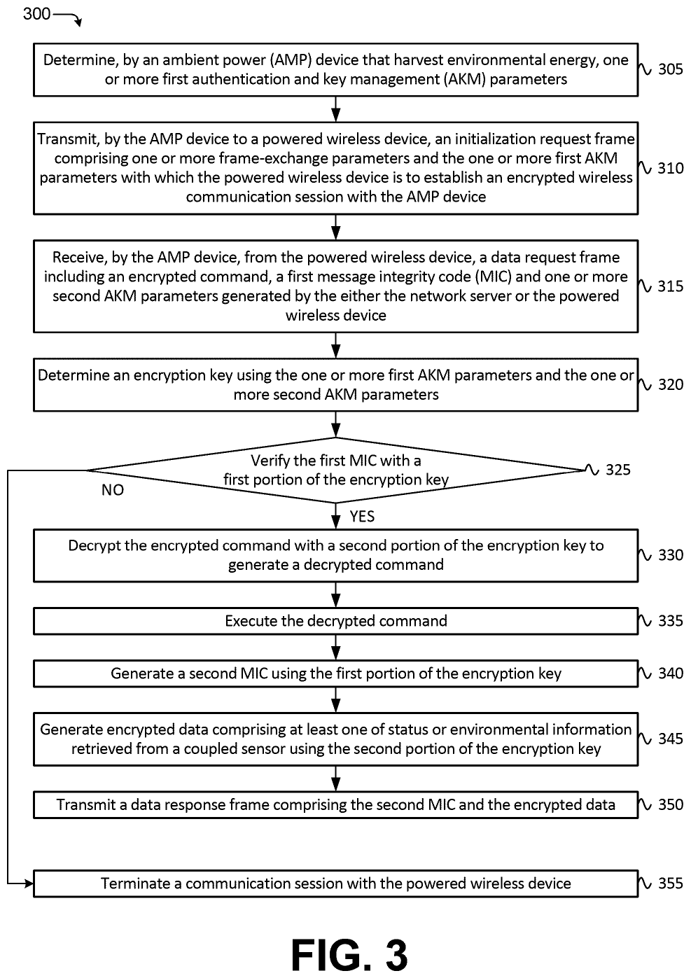

FIG. 3 is a flow diagram of an example method 300 for initiating secure communication by a wireless AMP device, according to other aspects of the disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. The method 300 can be performed by the wireless network 100 e.g., processing logic of the AMP device 120.

At operation 305, the processing logic determines one or more AKM parameters. In some embodiments, determining the one or more AKM parameters can include selecting an AKM method. The one or more AKM parameters can be determined based on the AKM method. The one or more AKM parameters can be determined using a secret shared between the AMP device 120 and either (i) the powered wireless device 110 or (ii) the network server 130. In some embodiments, the secret describes an elliptical curve. In some embodiments, the one or more AKM parameters include one or more of Simultaneous Authentication of Equals (SAE) information, a password-based challenge, an ID, or information for another type of encryption. In some embodiments where the secret describes an elliptical curve, the one or more AKM parameters include a scalar value corresponding to a random, or pseudo-random number and an element value corresponding to a location along the elliptical curve selected using the scalar value (e.g., the random or pseudo-random number).

At operation 310, the processing logic causes the AMP device 120 to transmit an initialization request frame to a powered wireless device 110. The initialization request frame can include the one or more first AKM parameters. In some embodiments, the initialization request frame includes one or more frame exchange parameters. In some embodiments, the one or more frame-exchange parameters can include a frame type, a session number, and physical layer (PHY) parameters. In some embodiments, the one or more frame-exchange parameters include a first AMP device identifier corresponding to a first AMP device 120 of many AMP devices 120 (e.g., an ID of the AMP device 120). In some embodiments, the initialization request frame can further include a checksum value. In some embodiments, the processing logic causes the powered wireless device 110 to transmit the initialization request and/or causes the powered wireless device 110 to perform subsequent operations (e.g., operation 310-350).

At operation 315, the processing logic causes the AMP device 120 to receive a data request frame. The data request frame can include an encrypted command. In some embodiments, the data request frame includes AKM parameters generated either by the network server 130 or the powered wireless device 110. In some embodiments, the data request frame includes error-checking data, such as a message integrity code (MIC).

At operation 320, the processing logic determines an encryption key using at least information from the data request frame. In some embodiments, the processing logic further uses the first one or more AKM parameters (e.g., of operation 305) to determine the encryption key. In some embodiments, the information from the data request frame includes one or more second AKM parameters.

At operation 325, the processing logic verifies, using a first portion of the encryption key, whether the MIC. If the MIC is verified, processing logic proceeds to operation 330. If the MIC cannot be verified, processing logic proceeds to operation 355, where the communication session with the powered wireless device 110 can be terminated. In some embodiments, at operation 355, responsive to failing to verify the MIC with a first portion of the encryption key, processing logic terminates an encrypted network session initiated with the powered wireless device 110.

At operation 330, the processing logic decrypts the encrypted command with a second portion of the encryption key to generate a decrypted command.

At operation 335, the processing logic executes the decrypted command. In some embodiments, to execute the encrypted command processing logic generates a data response frame and causes the data response frame to be transmitted to the powered wireless device 110. The data response frame can include encrypted data. In some embodiments, the encrypted data can include at least one of a status or environmental data retrieved from a coupled sensor. In some embodiments, the data response frame can include a second MIC.

At operation 340, the processing logic generates a second MIC using the first portion of the encryption key.

At operation 345, the processing logic generates encrypted data comprising at least one of status or environmental information retrieved from a coupled sensor using the second portion of the encryption key.

At operation 350, the processing logic causes the AMP device 120 to transmit a data response frame to the powered wireless device 110. The data response frame can include the second MIC and the encrypted data.

At operation 355, as described above, the method 300 can terminate if any of the preceding operations fail, e.g., at operation 325.

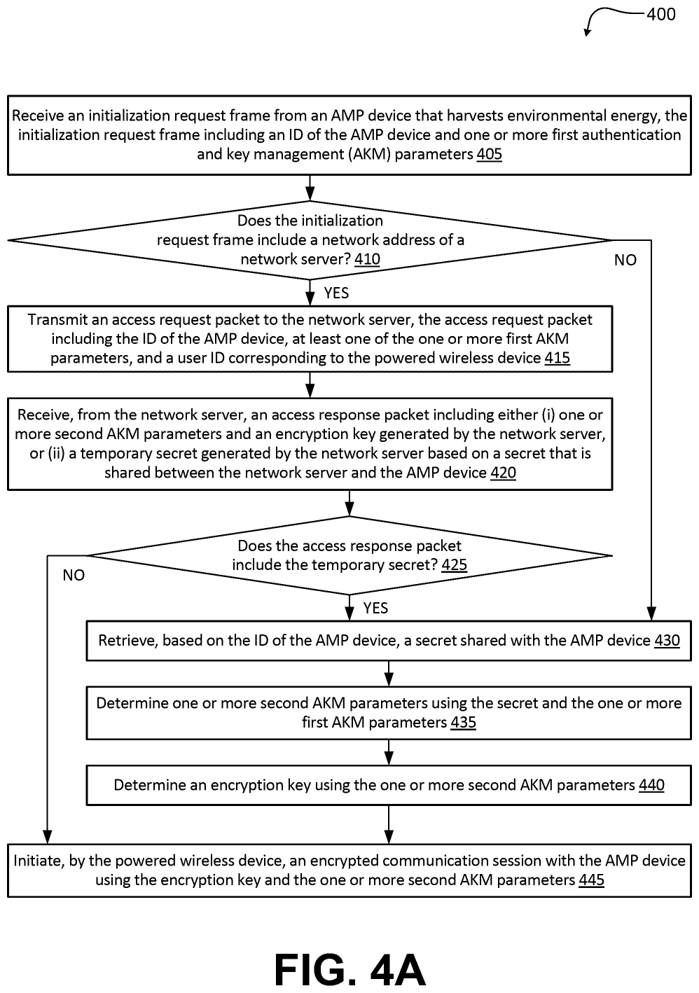

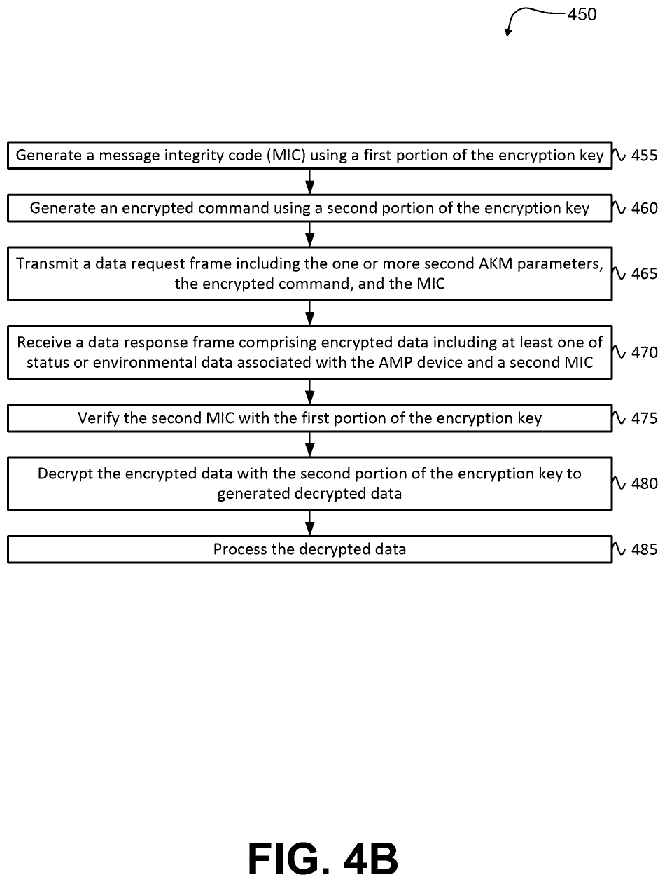

FIG. 4A is a flow diagram of an example method 400 for initiating secure communication by a wireless AMP device, according to some aspects of the disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 can be performed by the wireless network 100, e.g., processing logic of the powered wireless device 110.

At operation 405, the processing logic causes the powered wireless device 110 to receive an initialization request frame from an AMP device 120. The initialization request frame can include an ID of the AMP device 120. In some embodiments, the initialization request frame can include one or more first AKM parameters. In some embodiments, the one or more first AKM parameters include one or more of Simultaneous Authentication of Equals (SAE) information, a password-based challenge, an ID, or information for another type of encryption. In some embodiments where the secret describes an elliptical curve, the one or more AKM parameters include a scalar value corresponding to a random, or pseudo-random number and an element value corresponding to a location along the elliptical curve selected using the scalar value (e.g., the random or pseudo-random number). In some embodiments, the initialization request frame further includes one or more frame-exchange parameters and a checksum value. In some embodiments, the ID response frame can further include a frame type. In some embodiments, the one or more frame-exchange parameters include a frame type, a session number, and physical layer (PHY) parameters. In some embodiments, the processing logic causes the powered wireless device 110 to perform subsequent operations (e.g., operations 410-445).

At operation 410, processing logic determines whether the initialization request frame includes a network address of a network server 130. If the initialization request frame does include a network address, the processing logic proceeds to operation 415. If the initialization request frame does not include a network address, the processing logic proceeds to operation 430.

At operation 415, responsive to determining the initialization request frame includes the network address, the processing logic causes the powered wireless device 110 to transmit an access request packet to the network server 130 at the network address. The access request packet can include the ID of the AMP device 120. In some embodiments, the access request packet includes a user ID corresponding to the powered wireless device 110. In some embodiments, the access request packet includes one or more first AKM parameters.

At operation 420, the processing logic causes the powered wireless device 110 to receive an access response packet from the network server 130. The access response packet can include information generated by the network server 130 based at least on a secret that is shared between the network server 130 and the AMP device 120. In some embodiments, the access response packet includes one or more second AKM parameters and an encryption key generated by the network server 130. In alternative embodiments, the access response packet includes a temporary secret generated by the network server 130. The temporary secret can be generated based at least on a nonce value generated by the AMP device 120, and transmitted to the network server 130 by the powered wireless device 110 in the access request frame.

At operation 425, the processing logic determines whether the access response packet includes the temporary secret generated by the network server 130. If the access response packet includes the temporary secret, the processing logic proceeds to operation 430. If the access response packet does not include the temporary secret, the processing logic proceeds to operation 445.

At operation 430, responsive to determining the access response packet does include the temporary secret, the processing logic retrieves a secret that is shared between the powered wireless device 110 and the AMP device 120 from memory of the powered wireless device 110. In some embodiments, the secret can be retrieved based on an ID of the AMP device 120 (e.g., received in the initialization request frame at operation 405). In some embodiments, as described in operation 410, the processing logic at operation 430 can be performed responsive to determining the initialization request frame does not include a network address of the network server 130. That is, the operation 430 can follow the operation 405 when the wireless network 100 does not include a network server 130 for performing communication authorization on behalf of the powered wireless device 110.

At operation 435, the processing logic determines one or more second AKM parameters using at least the retrieved secret. In some embodiments the processing logic can further use one or more first AKM parameters to determine the one or more second AKM parameters.

At operation 440, the processing logic determines an encryption key using the one or more second AKM parameters.

At operation 445, the processing logic causes the powered wireless device 110 to initiate an encrypted wireless communication session with the AMP device 120. The encrypted wireless communication session can be initiated using the encryption key. In some embodiments, the encrypted wireless communication session can be initiated, in part using the second AKM parameters. In some embodiments, as described in operation 425, the processing logic at operation 445 can be performed responsive to determining the access response packet does not include a temporary secret generated by the network server 130. That is, the operation 445 can follow the operation 420 when the network server 130 generates the one or more second AKM parameters and encryption key on behalf of the powered wireless device 110, and securely communicates the second AKM parameters and encryption key to the powered wireless device 110.

While not illustrated, the method 400 can further include one or more error-checking operations performed between any of the operations 405-445. In some embodiments, an error-checking operation includes verifying a checksum received in a communication from the AMP device 120 (e.g., the initialization request frame). In some embodiments, an error-checking operation includes verifying cyclic redundancy check (CRC) data received in a communication from the AMP device 120 (e.g., the initialization request frame). If the error-checking operation fails, the method 400 can terminate, e.g., a procedure for establishing an encrypted wireless communication between the powered wireless device 110 and the AMP device 120 is halted.

In some embodiments, the operation 445 can include additional operations, e.g., operations 450-480 (illustrated in FIG. 4B).

FIG. 4B is a flow diagram of an example method 450 for initiating secure communication by a wireless AMP device, according to some aspects of the disclosure. The method 450 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 450 can be performed by the wireless network 100, e.g., processing logic of the powered wireless device 110.

At operation 455, the processing logic generates a message integrity code (MIC) using a first portion of the encryption key. In some embodiments, the operation 455 follows the operation 440 described with reference to FIG. 4A.

At operation 460, the processing logic generates an encrypted command using a second portion of the encryption key.

At operation 465, the processing logic causes the powered wireless device 110 to transmit a data request frame to the AMP device 120, the data request frame including the one or more second AKM parameters, the encrypted command, and the MIC.

At operation 470, the processing logic causes the powered wireless device 110 to receive a data response frame from the AMP device 120, the data response frame including encrypted data and a second MIC. In some embodiments, the encrypted data includes at least one of status or environmental data associated with the AMP device 120 (e.g., collected by a sensor coupled to the AMP device 120).

At operation 475, the processing logic verifies the second MIC with the first portion of the encryption key.

At operation 480, the processing logic decrypts the encrypted data of the data response frame using the second portion of the encryption key to generate decrypted data.

At operation 485, the processing logic processes the decrypted data.

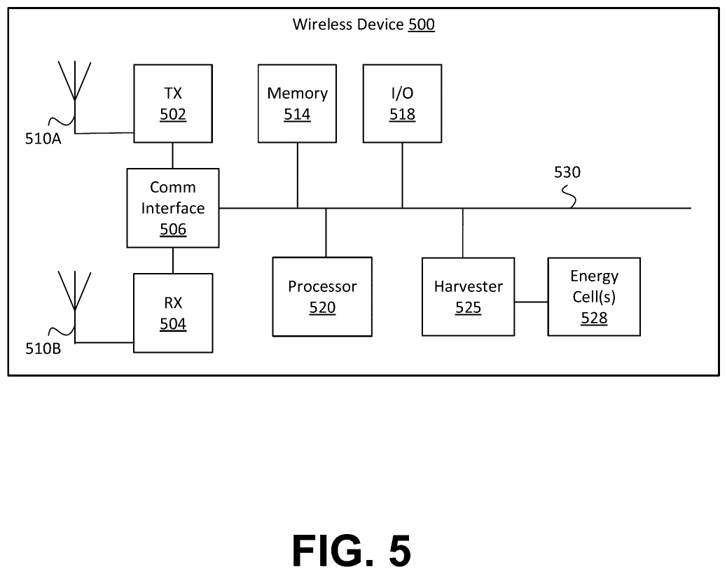

FIG. 5 is a simplified block diagram of an example wireless device 500, which may represent any of the powered wireless device 110 or client wireless devices discussed herein according to aspects of the disclosure. For example, the client wireless devices may include the AMP device 120. In at least some embodiments, the wireless device 500 includes, but is not be limited to, a transmitter 502 or TX (e.g., a WLAN transmitter), a receiver 504 or RX (e.g., a WLAN receiver), a communications interface 506, a TX antenna 510A coupled to the transmitter 502, an RX antenna 510B coupled to the receiver 504, a memory 514, one or more input/output (I/O) devices 518 (such as a display screen, a touch screen, a keypad, and the like), a processor 520, an energy harvester 525, and energy cells 528. These components can all be coupled to a communications bus 530. In some embodiments, aspects of the communication interface 506 work with the processor 520 to perform operations or that function as a processing device of the wireless device 500. In some embodiments, there is a single antenna and multiplexing logic to switch use of the antenna between the TX and RX. In some embodiments, the powered wireless device 110 has no energy harvester, and instead has a battery and/or is analog current (AC)-powered.

In at least some embodiments, the memory 514 includes storage to store instructions executable by the processor 520 and/or data generated by the communication interface 506. In various embodiments, frontend components such as the transmitter 502, the receiver 504, the communication interface 506, and one or more antennas are adapted with or configured for WLAN and WLAN-based frequency bands, e.g., Wi-Fi®, Bluetooth® (BT), Bluetooth® Low Energy (LBE), Ultra-Wideband (UWB), Z-wave™, Zigbee®, LoRa™, Wireless Smart Utility Network® (Wi-SUN®), or other wireless protocol. While some of the protocols may also be referred to as personal area network (PAN) technology, for simplicity, all are broadly referred to as WLAN technology. Future protocols are also envisioned.

In various embodiments, the communications interface 506 is integrated with the transmitter 502 and the receiver 504, e.g., as a frontend of the wireless device 500. The communication interface 506 may coordinate, as directed by the processor 520, to request/receive packets from other wireless devices or those that reflect off of objects. The communications interface 506 can further process data symbols received by the receiver 504 in a way that the processor 520 can perform further processing, including identifying and parsing data packets received within the wireless signals. In some embodiments, the transmitter 502, receiver 504, communication interface 506, and antennas 510A and 510B can be referred to herein as a “wireless communication circuit.”

In various embodiments, the energy harvester 525 performs operations disclosed herein in order to capture electromagnetic or RF signals and other types of non-RF energy, e.g., light, temperature gradients, pressure differential, mechanical vibrations, wind energy, and the like, which were discussed with referenced to FIG. 1A and FIG. 1B. As discussed, the energy harvester 525, with reference to harvesting energy from RF wireless signals, may be a multi-band harvester in being configured to harvest energy from multiple ranges of frequencies that define different RF bands. In these embodiments, the energy harvester 525 is also configured to store the harvested energy within the energy cells 528, which then operate as a power source for the wireless device 500.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for Universal Serial Bus (USB) Type-C (USB-C) or USB Power Delivery (PD) mode-transition architecture described herein. The non-transitory computer-readable storage medium may include, but is not limited to, electromagnetic storage medium, read-only memory (ROM), random-access memory (RAM), erasable programmable memory (e.g., Erasable and Programmable Read Only Memory (EPROM) and Electrically Erasable and Programmable Read Only Memory (EEPROM)), flash memory, or another now-known or later-developed non-transitory type of medium that is suitable for storing information.

Although the operations of the circuit(s) and block(s) herein are shown and described in a particular order, in some embodiments the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method comprising:
determining, by an ambient power (AMP) device that harvests environmental energy, one or more first authentication and key management (AKM) parameters; and
transmitting, by the AMP device, to a powered wireless device, an initialization request frame comprising one or more frame-exchange parameters and the one or more first AKM parameters with which the powered wireless device is to establish an encrypted wireless communication session with the AMP device.

2. The method of claim 1, further comprising, responsive to failing to receive a response to the initialization request frame, retransmitting the initialization request frame.

3. The method of claim 1, wherein determining the one or more first AKM parameters comprises:
selecting an AKM method to be employed;
retrieving, from memory of the AMP device, a secret that is shared with the powered wireless device; and
generating, using the secret and the AKM method, the one or more first AKM parameters.

4. The method of claim 3, further comprising:
receiving, by the AMP device, from the powered wireless device, a data request frame including an encrypted command, a first message integrity code (MIC), and one or more second AKM parameters;
determining an encryption key using the one or more first AKM parameters and the one or more second AKM parameters;
verifying the first MIC with a first portion of the encryption key;
decrypting the encrypted command with a second portion of the encryption key to generate a decrypted command; and
executing the decrypted command.

5. The method of claim 4, wherein executing the decrypted command comprises:
generating a second MIC using the first portion of the encryption key;
generating encrypted data using the second portion of the encryption key to encrypt data including at least one of status or environmental data retrieved from a coupled sensor; and
transmitting, to the powered wireless device, a data response frame comprising the second MIC and the encrypted data.

6. The method of claim 3, further comprising:
receiving, by the AMP device, from the powered wireless device, a data request frame including an encrypted command, a first message integrity code (MIC), and one or more second AKM parameters;
determining an encryption key using the one or more first AKM parameters and the one or more second AKM parameters;
failing to verify the first MIC with a first portion of the encryption key;
terminating a procedure of establishing the encrypted wireless communication session with the powered wireless device; and
retransmitting the initialization request frame to the powered wireless device.

7. The method of claim 1, wherein determining the one or more first AKM parameters comprises:
selecting an AKM method to be employed;
retrieving, from memory of the AMP device, a secret that is shared with a network server communicatively coupled to the powered wireless device; and
generating, using the secret and the AKM method, the one or more first AKM parameters.

8. The method of claim 7, further comprising:
receiving, by the AMP device, from the powered wireless device, a data request frame including an encrypted command generated by the powered wireless device using a first encryption key determined by the network server, a first message integrity code (MIC), and one or more second AKM parameters determined by the network server;
determining a second encryption key using the one or more first AKM parameters and the one or more second AKM parameters;
verifying the first MIC with a first portion of the second encryption key;
decrypting the encrypted command with a second portion of the second encryption key to generate a decrypted command; and
executing the decrypted command.

9. The method of claim 7, wherein the initialization request frame further comprises a nonce value generated by the AMP device, the method further comprising:
receiving, by the AMP device, from the powered wireless device, a data request frame including an encrypted command generated by the powered wireless device using a first encryption key determined by the network server using at least the nonce value, a first message integrity code (MIC), and one or more second AKM parameters determined by the network server;
determining a second encryption key, using the one or more first AKM parameters and the one or more second AKM parameters;
verifying the first MIC with a first portion of the second encryption key;
decrypting the encrypted command with a second portion of the second encryption key to generate a decrypted command; and
executing the decrypted command.

10. A method comprising:
receiving, by a powered wireless device, an initialization request frame from an ambient power (AMP) device that harvests environmental energy, the initialization request frame including an ID of the AMP device and one or more first authentication and key management (AKM) parameters;
retrieving, based on the ID of the AMP device, a secret that is shared with the AMP device;
determining one or more second AKM parameters using the secret and the one or more first AKM parameters;
determining an encryption key using the one or more second AKM parameters; and
initiating, by the powered wireless device, an encrypted wireless communication session with the AMP device using the encryption key.

11. The method of claim 10, wherein retrieving the secret that is shared with the AMP device comprises:
accessing, based on the ID of the AMP device, an entry in a data structure comprising an identification of the secret that is shared with the AMP device; and
retrieving, using the identification, the secret from memory of the powered wireless device.

12. The method of claim 10, wherein initiating the encrypted wireless communication session with the AMP device comprises:
generating a message integrity code (MIC) using a first portion of the encryption key;
generating an encrypted command using a second portion of the encryption key; and
transmitting, by the powered wireless device, to the AMP device, a data request frame including the one or more second AKM parameters, the encrypted command, and the MIC.

13. The method of claim 10, further comprising:
determining the initialization request frame includes a network address of a network server communicatively coupled to the powered wireless device;
transmitting an access request packet to the network server, wherein the access request packet includes the ID of the AMP device, at least one of the one or more first AKM parameters, and a user ID corresponding to the powered wireless device;
receiving, from the network server, an access response packet including:
the one or more second AKM parameters; and
the encryption key; and
initiating the encrypted wireless communication session with the AMP device using the encryption key and the one or more second AKM parameters.

14. The method of claim 13, wherein initiating the encrypted wireless communication session with the AMP device comprises:
generating a message integrity code (MIC) using a first portion of the encryption key;
generating an encrypted command using a second portion of the encryption key; and
transmitting, by the powered wireless device to the AMP device, a data request frame including the one or more second AKM parameters, the encrypted command, and the MIC.

15. A wireless device comprising:
an ambient power (AMP) collection circuit configured to harvest environmental energy;
a wireless communication circuit; and
a processing device coupled to the AMP collection circuit and the wireless communication circuit, the processing device to:
determine one or more first authentication and key management (AKM) parameters; and
transmit, by the wireless communication circuit, an initialization request frame comprising one or more frame-exchange parameters and the one or more first AKM parameters with which a powered wireless device is to establish an encrypted wireless communication session with the wireless device.

16. The wireless device of claim 15, wherein, responsive to failing to receive a response to the initialization request frame, the processing device is further to retransmit the initialization request frame to the powered wireless device.

17. The wireless device of claim 15, wherein, to determine the one or more first AKM parameters, the processing device is to:
select an AKM method to be employed;
retrieve, from memory of the wireless device, a secret that is shared with the powered wireless device; and
generate, using the secret and the AKM method, the one or more first AKM parameters.

18. The wireless device of claim 17, wherein the processing device is further to:
receive, by the wireless communication circuit, from the powered wireless device, a data request frame including an encrypted command, a first message integrity code (MIC), and one or more second AKM parameters;
determine an encryption key using the one or more first AKM parameters and the one or more second AKM parameters;
verify the first MIC with a first portion of the encryption key;
decrypt the encrypted command with a second portion of the encryption key to generate a decrypted command; and
execute the decrypted command.

19. The wireless device of claim 15, wherein, to determine the one or more first AKM parameters, the processing device is to:
select an AKM method to be employed;
retrieve, from memory of the wireless device, a secret that is shared with a network server communicatively coupled to the powered wireless device; and
generate, using the secret and the AKM method, the one or more first AKM parameters.

20. The wireless device of claim 19, wherein the processing device is further to:
receive, by the wireless communication circuit, from the powered wireless device, a data request frame including an encrypted command generated by the powered wireless device using a first encryption key determined by the network server, a first message integrity code (MIC), and one or more second AKM parameters determined by the network server;
determine a second encryption key using the one or more first AKM parameters and the one or more second AKM parameters;
verify the first MIC with a first portion of the second encryption key;
decrypt the encrypted command with a second portion of the second encryption key to generate a decrypted command; and
execute the decrypted command.

21. The wireless device of claim 20, wherein the processing device is further to:
generate a nonce value using the secret that is shared with the network server; and
include the nonce value in the initialization request frame.
